(19) United States
(12) Patent Application Publication
(10) Pub. No.: US 2023/0019149 A1
(43) Pub. Date: Jan. 19, 2023

(54) AIR CONDITIONING SYSTEM

(71) Applicant: DAIKIN INDUSTRIES, LTD., Osaka-si (JP)

(72) Inventor: Kouji TATSUMI, Osaka-shi (JP)

(73) Assignee: DAIKIN INDUSTRIES, LTD., Osaka-si (JP)

(21) Appl. No.: 17/955,704

(22) Filed: Sep. 29, 2022

Related U.S. Application Data
(63) Continuation of application No. PCT/JP2021/012264, filed on Mar. 24, 2021.

(30) Foreign Application Priority Data
Mar. 31, 2020 (JP) 2020-062863

(51) Int. Cl. F24F 11/72

(52) U.S. Cl. CPC F24F 11/72

(57) ABSTRACT

An air conditioning system includes a plurality of first units each including a first fan configured to blow supply air into a target space. A second unit distributes the supply air to the plurality of first units through a duct. In the second unit, a heat exchanger subjects indoor air and outside air introduced by an outside air supply fan, to heat exchange. The second unit thus generates the supply air and sends the supply air to the duct. A controller controls at least the plurality of first fans so as to inhibit the supply air or the outside air from flowing out of an intake port, by setting a sum of airflow volumes from the plurality of first units to be equal to or more than an airflow volume from the outside air supply fan.

### CROSS REFERENCE TO RELATED APPLICATIONS

This application is a Continuation of PCT International Application No. PCT/JP2021/012264, filed on Mar. 24, 2021, which claims priority under 35 U.S.C. 119(a) to Patent Application No. 2020-062863, filed in Japan on Mar. 31, 2020, all of which are hereby expressly incorporated by reference into the present application.

### TECHNICAL FIELD

The present disclosure relates to an air conditioning system including a duct for distributing air.

### BACKGROUND ART

For example, Patent Literature 1 (JP H10-253132 A) discloses a known air conditioning system including: an air conditioning unit including a heat exchanger and an air conditioning fan; a plurality of ventilation units each including a fan; and ducts through which the air conditioning unit distributes conditioned air to the ventilation units. In this air conditioning system, each fan has a number of rotations to be controlled for conditioning air in a room.

### SUMMARY

A first aspect is directed to an air conditioning system including a plurality of first units, a second unit, a duct, a second fan, and a controller. The plurality of first units each include a first fan configured to blow first air into a target space. The second unit includes a heat exchanger and an intake port.

Through the duct, the second unit distributes the first air to the plurality of first units. The second fan introduces second air into the second unit. The controller controls the plurality of first fans of the plurality of first units. The second unit makes exchange heat at least the second air introduced by the second fan with the heat exchanger to generate the first air and sends the first air to the duct. The controller controls at least the plurality of first fans so as to inhibit the first air or the second air from flowing out of the intake port, by setting a sum of airflow volumes from the plurality of first units to be equal to or more than an airflow volume from the second fan.

A second aspect is directed to the air conditioning system according to the first aspect, in which the plurality of first units each include a first airflow detector configured to detect the airflow volume from a corresponding one of the first units, and the controller controls the plurality of first fans in accordance with a result of comparison between a sum of airflow volumes detected by the plurality of first airflow detectors of the plurality of first units and the airflow volume from the second fan.

A third aspect is directed to the air conditioning system according to the first or second aspect, further including a second airflow detector configured to detect an airflow volume from the second fan, in which the controller controls the plurality of first fans in accordance with a result of comparison between the airflow volume detected by the second airflow detector and the sum of the airflow volumes from the plurality of first units.

### BRIEF DESCRIPTION OF THE DRAWINGS

FIG. 1 is a conceptual diagram of a configuration of an air conditioning system according to an embodiment.

FIG. 2 is a block diagram of a configuration of a controller in the air conditioning system illustrated in FIG. 1.

FIG. 3 is a conceptual diagram of an exemplary configuration of an air conditioning system according to a modification.

FIG. 4 is a block diagram of a configuration of a controller in the air conditioning system illustrated in FIG. 3.

FIG. 5 is a conceptual diagram of an exemplary configuration of an air conditioning system according to another modification.

FIG. 6 is a block diagram of a configuration of a controller in the air conditioning system illustrated in FIG. 5.

### DESCRIPTION OF EMBODIMENTS

(1) General Configuration

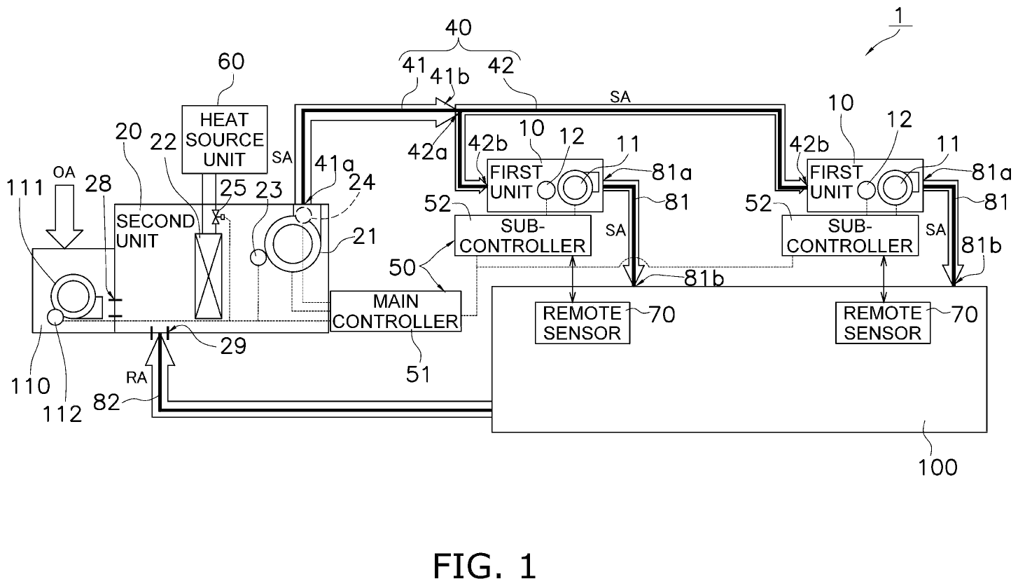

An air conditioning system 1 illustrated in FIG. 1 includes a plurality of first units 10, a second unit 20, a duct 40, a controller 50, and an outside air introduction unit 110. The plurality of first units 10 each include a first fan 11. The second unit 20 includes a heat exchanger 22 and intake ports 28 and 29. Each of the first fans 11 blows supply air SA (first air) out of a corresponding one of the first units 10 into a target space 100. The target space 100 is, for example, a room in a building. The room is, for example, a space where the movement of air is restricted by a floor, a ceiling, and a wall. A plurality of first units 10 are placed in one or more target spaces 100. FIG. 1 illustrates, as a typical example of an air conditioning system 1 including a plurality of first units 10, an air conditioning system 1 including two first units 10 placed in one target space 100. However, the number of first units 10 to be placed in one target space 100 may be three or more, which is set as appropriate. The second unit 20 includes the intake ports 28 and 29. The second unit 20 introduces outside air OA from the outside air introduction unit 110 through the intake port 28. The intake port 29 of the second unit 20 is connected to the target space 100 through an air flow path 82. Indoor air RA returns from the target space 100 to the second unit 20 through the air flow path 82 and the intake port 29.

The outside air introduction unit 110 includes an outside air supply fan 111. The outside air introduction unit 110 causes the outside air supply fan 111 to take in outside air OA from the outside of the target space 100 and sends the outside air OA to the second unit 20 through the intake port 28. The outside air supply fan 111 has a number of rotations that is changeable. Larger the number of rotations is, larger a volume of outside air OA is. The outside air supply fan 111 is controlled by a main controller 51. In this embodiment, the outside air OA to be introduced into the second unit 20 corresponds to second air. In addition, the outside air supply fan 111 configured to introduce the second air (the outside air OA) into the second unit 20 corresponds to a second fan.

Through the duct 40, the second unit 20 distributes supply air SA (first air) to the plurality of first units 10 so that the first fans 11 send the supply air SA (the first air). The duct 40 include a main pipe 41 and branch pipes 42 branched off the main pipe 41. As an example, the main pipe 41 illustrated in FIG. 1 has an inlet 41a connected to the second unit 20. The main pipe 41 of the duct 40 also has an outlet 41b connected to inlets 42a of the branch pipes 42. The branch pipes 42 have a plurality of outlets 42b connected to the plurality of first units 10.

The second unit 20 also includes an air supply fan 21. In the second unit 20, the air supply fan 21 introduces indoor air RA and outside air OA (second air), and the heat exchanger 22 subjects the indoor air RA and the outside air OA (the second air) to heat exchange. The second unit 20 thus generates supply air SA (first air) and sends the supply air SA (the first air) to the duct 40. In this embodiment, air to be blown by the air supply fan 21 flows into the duct 40 without fail.

The first units 10 are connected to the target space 100 through air flow paths 81. The air flow paths 81 have inlets 81a connected to the first units 10. In the first units 10, the first fans 11 generate air currents from the outlets 42b of the duct 40 to the inlets 81a of the air flow paths 81. In other words, the first fans 11 suck in the supply air SA from the outlets 42b of the branch pipes 42. Each of the first fans 11 changes its number of rotations, thereby changing a static pressure in a corresponding one of the first units 10 (i.e., in front of the inlet 81a of a corresponding one of the air flow paths 81). In a case where a static pressure at the duct 40 is constant, each of the first fans 11 increases its number of rotations, thereby raising the static pressure in a corresponding one of the first units 10 (i.e., in front of the inlet 81a of a corresponding one of the air flow paths 81). When the static pressure in each of the first units 10 rises, a volume of supply air SA flowing through a corresponding one of the air flow paths 81 increases. A change in volume of supply air SA brings about a change in airflow volume to be sent to the target space 100 through an outlet 81b of each air flow path 81.

The controller 50 includes the main controller 51 and a plurality of sub-controllers 52. The main controller 51 and the plurality of sub-controllers 52 are connected to constitute the controller 50. The main controller 51 controls a number of rotations of the air supply fan 21. In other words, the main controller 51 controls an output from the air supply fan 21. When the output from the air supply fan 21 increases, a state of the air supply fan 21 changes such that an airflow volume from air supply fan 21 increases.

One sub-controller 52 is provided for each first unit 10. Each of the sub-controllers 52 issues an instruction regarding a change in airflow volume to a corresponding one of the first fans 11. Each of the sub-controllers 52 stores a target air volume. When a supply air volume is insufficient with respect to the target air volume, each of the sub-controllers 52 issues an instruction to increase the number of rotations of a corresponding one of the first fans 11 (an instruction regarding a change in airflow volume). On the other hand, when the supply air volume is excessive with respect to the target air volume, each of the sub-controllers 52 issues an instruction to decrease the number of rotations of a corresponding one of the first fans 11 (an instruction regarding a change in airflow volume).

The controller 50 obtains, from the plurality of sub-controllers 52, information about the volume of supply air SA to be supplied from the plurality of first fans 11 into the target space 100. The information about the airflow volume includes, for example, information about an airflow volume to be supplied into the target space 100 per second. The controller 50 determines a requested output from the air supply fan 21, based on the obtained information about the airflow volume. The controller 50 controls an output from the air supply fan 21 so that the output becomes equal to the requested output thus determined. For example, each of the sub-controllers 52 obtains, from a corresponding one of the first units 10, a value of the airflow volume from the first unit 10. Each of the sub-controllers 52 outputs the value of the airflow volume to the main controller 51.

The controller 50 controls at least the plurality of first fans 11 so as to inhibit the supply air SA (the first air) or the outside air OA (the second air) from flowing out of the intake port 29 toward the outside of the second unit 20, by setting a sum of the airflow volumes from the plurality of first units 10 to be equal to or more than the airflow volume from the outside air supply fan 111 (the second fan).

(2) Specific Configuration

(2-1) Second Unit 20

The second unit 20 includes, in addition to the air supply fan 21, heat exchanger 22, and intake ports 28 and 29 which have already been described above, a third airflow detector 23, a temperature sensor 24, and a water regulation valve 25. The heat exchanger 22 receives, for example, cold water or hot water as a heating medium from a heat source unit 60. The heating medium to be supplied to the heat exchanger 22 may be, for example, brine in addition to cold water or hot water. Examples of the third airflow detector 23 may include, but not limited to, an air volume sensor, an air velocity sensor, and a differential pressure sensor.

The third airflow detector 23 detects an airflow volume to be supplied from the air supply fan 21. The third airflow detector 23 is connected to the main controller 51. The third airflow detector 23 transmits a value of the airflow volume detected by the third airflow detector 23, to the main controller 51. The airflow volume detected by the third airflow detector 23 corresponds to an airflow volume flowing through the main pipe 41 of the duct 40. In other words, the airflow volume detected by the third airflow detector 23 corresponds to a sum of airflow volumes supplied from the plurality of first units 10 to the target space 100.

The temperature sensor 24 detects a temperature of supply air SA to be sent from the air supply fan 21 to the duct 40. The temperature sensor 24 is connected to the main controller 51. The temperature sensor 24 transmits a value of the temperature detected by the temperature sensor 24, to the main controller 51.

The second unit 20 is connected to the target space 100 through the air flow path 82. The air supply fan 21 draws indoor air RA, which has returned from the target space 100 through the air flow path 82, into the second unit 20. The second unit 20 is connected to the outside air introduction unit 110. The outside air supply fan 111 blows outside air OA into the second unit 20 through the intake port 28. The indoor air RA drawn into the second unit 20 and the outside air OA pass through the heat exchanger 22 to turn into supply air SA, and then the supply air SA is sent to the duct 40. The indoor air RA and the outside air OA each passing through the heat exchanger 22 exchange heat with the cold water or hot water flowing through the heat exchanger 22, to thereby turn into conditioned air. Through the heat exchange by the heat exchanger 22, an amount of heat to be applied to the conditioned air (the supply air SA) is adjusted by the water regulation valve 25. The water regulation valve 25 has an opening degree to be controlled by the main controller 51. When the opening degree of the water regulation valve 25 increases, a quantity of water flowing through the heat exchanger 22 also increases, leading to an increase in amount of heat to be exchanged between the heat exchanger 22 and the supply air SA per unit time. On the other hand, when the opening degree of the water regulation valve 25 decreases, the quantity of water flowing through the heat exchanger 22 also decreases, leading to a decrease in amount of heat to be exchanged between the heat exchanger 22 and the supply air SA per unit time.

(2-2) First Unit 10

Each of the first units 10 includes a first airflow detector 12 in addition to the first fan 11 which has already been described above. Each of the first airflow detectors 12 detects an airflow volume sent from a corresponding one of the first fans 11. Each of the first airflow detectors 12 is connected to a corresponding one of the sub-controllers 52. Each of the first airflow detectors 12, when detecting a value of an airflow volume, transmits the value to a corresponding one of the sub-controllers 52. The airflow volume detected by each of the first airflow detectors 12 corresponds to an airflow volume flowing through a corresponding one of the air flow paths 81. In other words, the airflow volume detected by each of the first airflow detectors 12 corresponds to an airflow volume supplied from a corresponding one of the first units 10 to the target space 100. Examples of each first airflow detector 12 may include, but not limited to, an air volume sensor, an air velocity sensor, and a differential pressure sensor.

(2-3) Controller 50

The controller 50 is practicable using, for example, a computer. As illustrated in

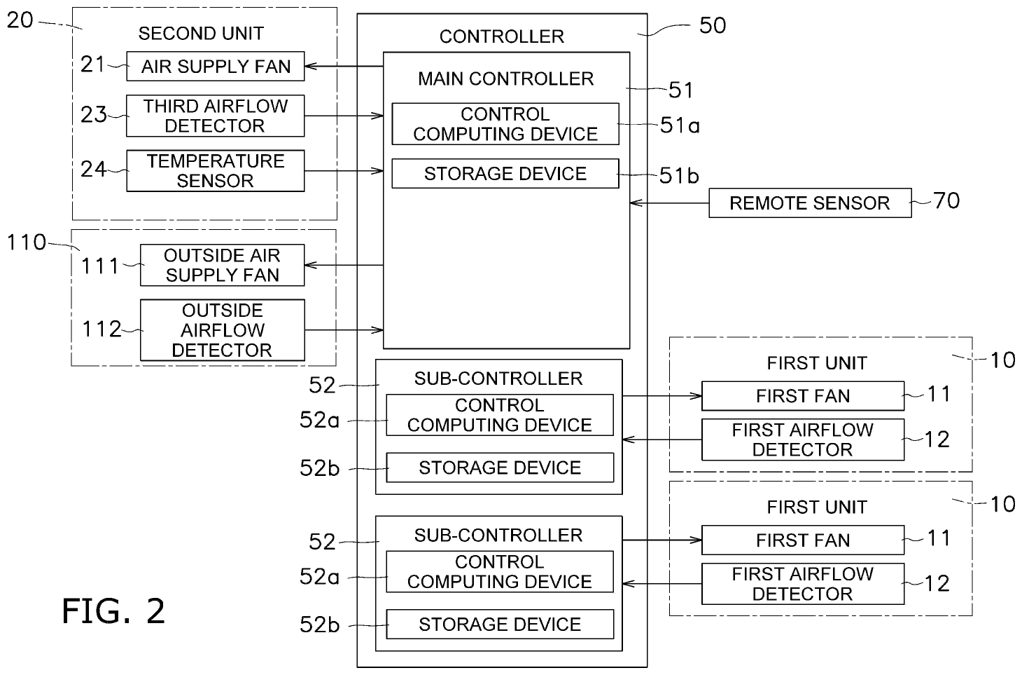

FIG. 2, the controller 50 includes control computing devices 51a and 52a, and storage devices 51b and 52b. Each of the control computing devices 51a and 52a may be a processor such as a central processing unit (CPU) or a graphics processing unit (GPU). Each of the control computing devices 51a and 52a reads a program from a corresponding one of the storage devices 51b and 52b, and executes predetermined image processing and arithmetic processing in accordance with this program. In addition, each of the control computing devices 51a and 52a writes a result of the arithmetic processing into a corresponding one of the storage devices 51b and 52b, and reads information from a corresponding one of the storage devices 51b and 52b, in accordance with this program. Various functional blocks illustrated in FIG. 2 are implemented by the control computing devices 51a and 52a. Each of the storage devices 51b and 52b may serve as a database.

(2-4) Remote Sensor 70

A plurality of remote sensors 70 each functions as a temperature sensor and a CO2 concentration sensor. Each of the remote sensors 70 is configured to transmit data indicative of a temperature and a CO2 concentration in the target space 100, to a corresponding one of the sub-controllers 52. For example, each of the remote sensors 70 is configured to detect a temperature and a CO2 concentration in the vicinity of an installation place in the target space 100.

(2-5)

The outside air introduction unit 110 includes an outside airflow detector 112 in addition to the outside air supply fan 111 which has already been described above. The outside airflow detector 112 functions as a second airflow detector configured to detect a volume of outside air OA to be sent to the second unit 20. The outside airflow detector 112 transmits a value of the volume of outside air OA thus detected, to the main controller 51. Examples of the outside airflow detector 112 may include, but not limited to, an air volume sensor, an air velocity sensor, and a differential pressure sensor.

(3) Operation of Air Conditioning System 1

Each of the sub-controllers 52 receives a value of a temperature detected in the target space 100, from a corresponding one of the remote sensors 70 connected thereto. Each of the sub-controllers 52 holds data indicative of a set temperature. For example, a remote controller (not illustrated) or the like sends the data indicative of the set temperature to each of the sub-controllers 52 beforehand. Each of the sub-controllers 52, when receiving the data indicative of the set temperature from, for example, the remote controller, stores the data in the storage device 52b (see FIG. 2) such as a memory incorporated therein. Each of the sub-controllers 52 transmits a value of the set temperature to the main controller 51. Based on the set temperature, the main controller 51 determines a temperature of supply air SA and a target air volume of each first unit 10, in accordance with the temperature detected by the corresponding remote sensor 70. The main controller 51 transmits a value of the target air volume to each of the sub-controllers 52.

The main controller 51 determines a target discharge pressure of the air supply fan 21, in accordance with a sum of the target air volumes to be supplied to the target space 100. The main controller 51 controls the number of rotations of the air supply fan 21 such that a discharge pressure at the air supply fan 21 becomes equal to the target discharge pressure. To this end, the second unit 20 may include a sensor configured to detect the discharge pressure at the air supply fan 21. The temperature of the supply air SA is adjusted by the water regulation valve 25. The main controller 51 causes the temperature sensor 24 to detect the temperature of the supply air SA and, simultaneously, adjusts the opening degree of the water regulation valve 25 such that the temperature of the supply air SA becomes equal to the determined temperature.

The main controller 51 receives a value of a CO₂ concentration detected in the target space 100, from each of the remote sensors 70 connected thereto. The main controller 51 holds data about a CO₂ concentration. Based on data about the CO₂ concentration, the main controller 51 determines an output from (a number of rotations of) the outside air supply fan 111, in accordance with the CO₂ concentration detected by the corresponding remote sensor 70.

The controller 50 controls the plurality of first fans 11 so as to inhibit supply air SA or outside air OA from flowing out of the intake ports 28 and 29 toward the outside of the second unit 20, by setting a sum AV of the airflow volumes from the plurality of first units 10 to be equal to or more than the airflow volume from the outside air supply fan 111. To this end, the controller 50 compares the sum of the airflow volumes detected by the plurality of first airflow detectors 12 of the plurality of first units 10, with the airflow volume from the outside air supply fan 111.

For example, the controller 50 compares a determined target air volume TV of the outside air supply fan 111 with a sum AV1 of the airflow volumes detected by the plurality of first airflow detectors 12, and controls the airflow volumes from the plurality of first fans 11 so as to satisfy a relation of AV1>TV.

Alternatively, for example, the controller 50 may be configured to compare a volume AV2 of air from the outside air supply fan 111 detected by the outside airflow detector 112 (the second airflow detector), with the sum AV1 of the airflow volumes detected by the plurality of first airflow detectors 12. In this case, for example, the controller 50 controls the plurality of first fans 11 so as to satisfy a relation of AV1≥AV2.

(4) Modifications

(4-1) Modification A

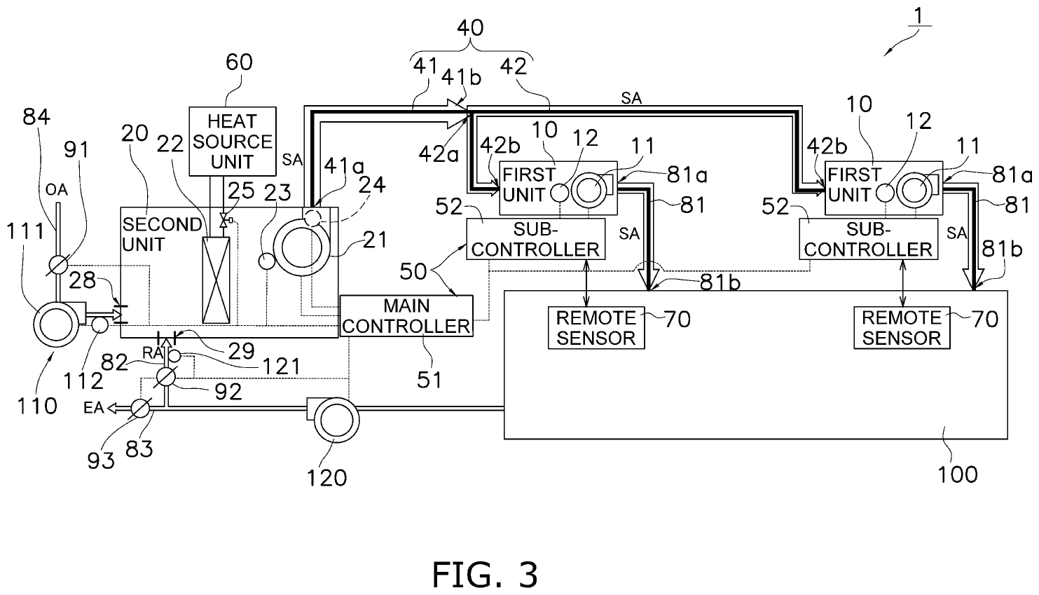

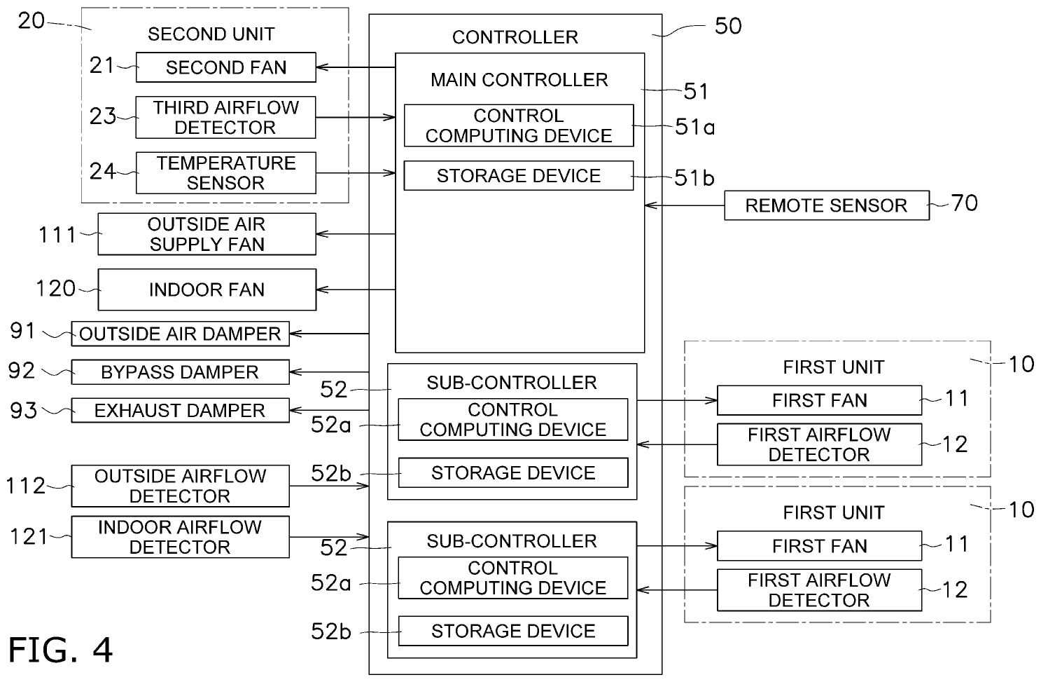

As illustrated in FIGS. 3 and 4, an air conditioning system 1 may include an indoor fan 120 configured to introduce indoor air RA into a second unit 20. In FIGS. 3 and 4, constituent components of the air conditioning system 1 similar to those of the air conditioning system 1 according to the embodiment illustrated in FIGS. 1 and 2 are denoted with the same reference signs as those denoting the similar constituent components of the air conditioning system 1 according to the embodiment illustrated in FIGS. 1 and 2; therefore, the description thereof will not be given here. Air to be blown from the indoor fan 120 flows through one of a path through which the air is introduced into the second unit 20 through an air flow path 82 and a path through which the air is exhausted from a room through an air flow path 83. In this case, with regard to the air to be blown from the indoor fan 120, air to be sent to the second unit 20 through an intake port 29 corresponds to indoor air RA, and air exhausted to the outside corresponds to exhaust air EA. The air conditioning system 1 may include a bypass damper 92 configured to adjust a flow rate of air flowing through the air flow path 82, and an exhaust damper 93 configured to adjust a flow rate of air flowing through the air flow path 83. The air conditioning system 1 may also include an outside air damper 91 provided for an outside air introduction unit 110 and configured to switch between an open state and a closed state of an air flow path 84 extending from the outside air introduction unit 110 to an intake port 28 of the second unit 20. For example, each of the outside air damper 91, the bypass damper 92, and the exhaust damper 93 is electrically opened and closed, and is controlled by a controller 50.

The outside air damper 91 is in a fully open state during an operation of an outside air supply fan 111 and is in a fully closed state during a stop of the outside air supply fan 111. The outside air supply fan 111 has a number of rotations to be controlled by a main controller 51 in accordance with a CO₂ concentration detected by a remote sensor 70. When a CO₂ concentration in the target space 100 increases, the main controller 51 increases the number of rotations of the outside air supply fan 111 to increase a volume of outside air OA to be supplied to the target space 100.

With an increase in volume of supply air SA to be supplied to the target space 100, a volume of indoor air RA returning from target space 100 also increases. Therefore, the main controller 51 changes a number of rotations of the indoor fan 120 in accordance with a number of rotations of an air supply fan 21. In increasing the number of rotations of the air supply fan 21, the main controller 51 increases the number of rotations of the indoor fan 120. For example, the main controller 51 changes the number of rotations of the indoor fan 120 in proportion to the number of rotations of the air supply fan 21. At this time, the main controller 51 changes an opening degree of the exhaust damper 93 in accordance with a number of rotations of the outside air supply fan 111. When the outside air supply fan 111 supplies air in volume, the main controller 51 increases the opening degree of the exhaust damper 93 and exhausts indoor air RA in volume. For example, the main controller 51 changes the opening degree of the exhaust damper 93 in proportion to the number of rotations of the outside air supply fan 111. The main controller 51 causes the bypass damper 92 to perform operation reverse to the operation of the exhaust damper 93. When the opening degree of the exhaust damper 93 increases, the main controller 51 decreases an opening degree of the bypass damper 92.

The air flow path 82 is provided with an indoor airflow detector 121. The indoor airflow detector 121 functions as a second airflow detector configured to detect a volume of indoor air RA to be sent to the second unit 20. The indoor airflow detector 121 transmits a value of the detected volume of indoor air RA, to the main controller 51. Examples of the indoor airflow detector 121 may include, but not limited to, an air volume sensor, an air velocity sensor, and a differential pressure sensor.

In this case, the outside air supply fan 111 and the indoor fan 120 each correspond to a second fan. Second air to be introduced into the second unit 20 refers to each of outside air OA to be introduced by the outside air supply fan 111 and indoor air RA to be introduced by the indoor fan 120.

The controller 50 controls a plurality of first fans 11 so as to inhibit supply air SA, indoor air RA, or outside air OA from flowing out of intake ports 28 and 29 toward the outside of the second unit 20, by setting a sum AV of airflow volumes from the plurality of first units 10 to be equal to or more than an airflow volume from the outside air supply fan 111 and an airflow volume from the indoor fan 120. To this end, the controller 50 compares a sum of airflow volumes detected by a plurality of first airflow detectors 12 of the plurality of first units 10, with the airflow volume from the outside air supply fan 111 and the airflow volume from the indoor fan 120.

For example, the controller 50 calculates a sum AV4 of a volume AV2 of air from the outside air supply fan 111 detected by an outside airflow detector 112 (a second airflow detector) and a volume AV3 of air from the indoor fan 120 detected by the indoor airflow detector 121 (a second airflow detector). The controller 50 compares the sum AV4 with a sum AV1 of airflow volumes detected by the plurality of first airflow detectors 12. For example, the controller 50 controls the plurality of first fans 11 so as to satisfy a relation of AV1≥AV4.

In a case where the air flow path 84, through which outside air OA passes, is short in length, the air conditioning system 1 illustrated in FIG. 3 does not necessarily include the outside air supply fan 111. In this case, the main controller 51 controls an opening degree of the outside air damper 91 in accordance with a CO₂ concentration. When the CO2 concentration increases, the main controller 51 increases the opening degree of the outside air damper 91. In the case where the outside air supply fan 111 is omitted, the indoor fan 120 serves as a second fan. In addition, second air to be introduced into the second unit 20 refers to indoor air RA to be introduced by the indoor fan 120.

In this case, the controller 50 controls the plurality of first fans 11 so as to inhibit supply air SA or indoor air RA from flowing out of the intake ports 28 and 29 toward the outside of the second unit 20, by setting a sum AV of the airflow volumes from the plurality of first units 10 to be equal to or more than the airflow volume from the indoor fan 120. To this end, the controller 50 compares the sum of the airflow volumes detected by the plurality of first airflow detectors 12 of the plurality of first units 10, with the airflow volume from the indoor fan 120. For example, the controller 50 compares the volume AV3 of air from the indoor fan 120 detected by the indoor airflow detector 121 (the second airflow detector), with the sum AV1 of the airflow volumes detected by the plurality of first airflow detectors 12. For example, the controller 50 controls the plurality of first fans 11 so as to satisfy a relation of AV1≥AV3.

(4-2) Modification B

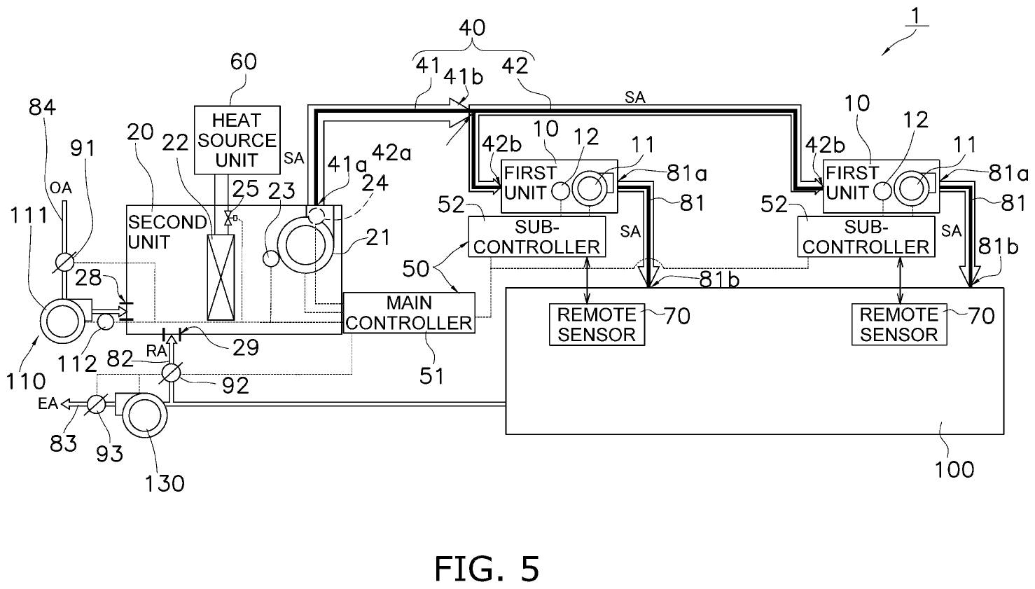

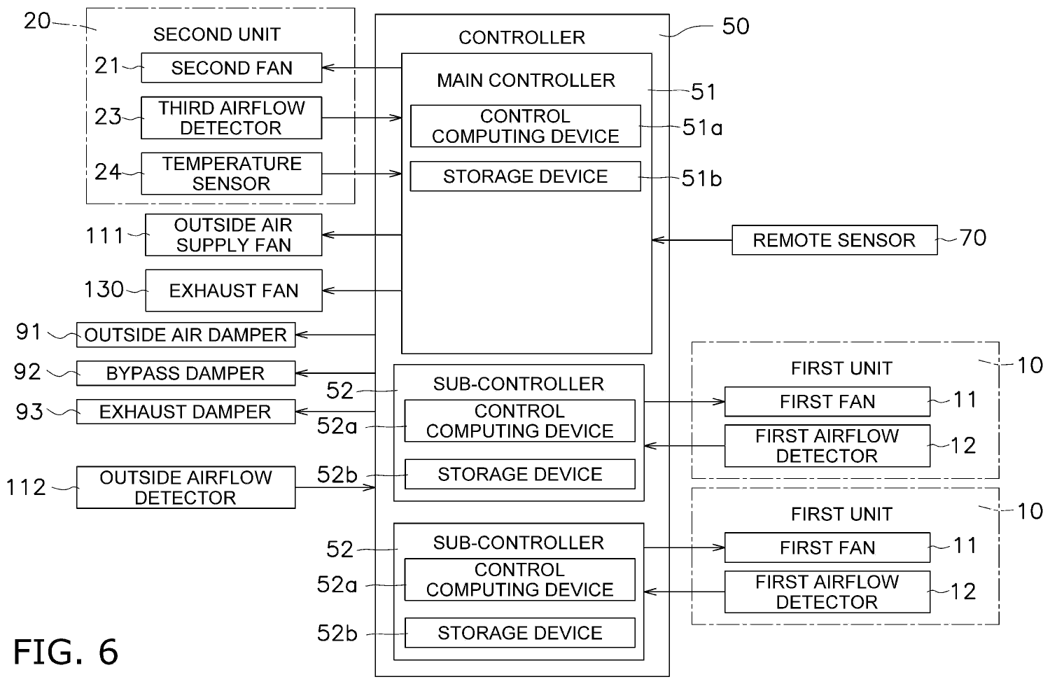

As illustrated FIGS. 5 and 6, an air conditioning system 1 may include an exhaust fan 130 configured to blow exhaust air EA toward the outside. In FIGS. 5 and 6, constituent components of the air conditioning system 1 similar to those of the air conditioning system 1 according to the embodiment illustrated in FIGS. 3 and 4 are denoted with the same reference signs as those denoting the similar constituent components of the air conditioning system 1 according to the embodiment illustrated in FIGS. 3 and 4; therefore, the description thereof will not be given here. The exhaust air EA blown from the exhaust fan 130 passes through an air flow path 83 and then flows through a path, through which the exhaust air EA is exhausted to the outside. With regard to air returning from a target space 100, air other than the exhaust air EA corresponds to indoor air RA to be introduced into a second unit 20 through an air flow path 82. The air conditioning system 1 may include a bypass damper 92 configured to adjust a flow rate of air flowing through the air flow path 82, and an exhaust damper 93 configured to adjust a flow rate of air flowing through the air flow path 83. The air conditioning system 1 may also include an outside air damper 91 provided for an outside air introduction unit 110 and configured to switch between an open state and a closed state of an air flow path 84 extending from the outside air introduction unit 110 to an intake port 28 of the second unit 20. For example, each of the outside air damper 91, the bypass damper 92, and the exhaust damper 93 is electrically opened and closed, and is controlled by a controller 50.

Each of the outside air damper 91 and the exhaust damper 93 is in a fully open state during an operation of an outside air supply fan 111 and is in a fully closed state during a stop of the outside air supply fan 111. The outside air supply fan 111 has a number of rotations to be controlled by a main controller 51 in accordance with a CO₂ concentration detected by a remote sensor 70. When a CO₂ concentration in the target space 100 increases, the main controller 51 increases the number of rotations of the outside air supply fan 111 to increase a volume of outside air OA to be supplied to the target space 100.

With an increase in volume of outside air OA to be taken in, the volume of exhaust air EA increases. Therefore, the main controller 51 changes a number of rotations of the exhaust fan 130 in accordance with the number of rotations of the outside air supply fan 111. In increasing the number of rotations of the outside air supply fan 111, the main controller 51 increases the number of rotations of the exhaust fan 130. For example, the main controller 51 changes the number of rotations of the exhaust fan 130 in proportion to the number of rotations of the outside air supply fan 111. At this time, the main controller 51 causes the bypass damper 92 to perform operation reverse to the operation of the exhaust fan 130. When the number of rotations of the exhaust fan 130 increases, the main controller 51 decreases an opening degree of the bypass damper 92.

In this case, the outside air supply fan 111 corresponds to a second fan. In addition, second air to be introduced into the second unit 20 refers to outside air OA to be introduced by the outside air supply fan 111. Accordingly, the controller 50 controls the plurality of first fans 11 so as to inhibit indoor air RA or outside air OA from flowing out of the second unit 20, in a manner similar to that described in the foregoing embodiment.

(4-3) Modification C

The foregoing embodiment concerns the case where the main controller 51 controls the number of rotations of the outside air supply fan 111. Alternatively, the main controller 51 may switch between an ON state and an OFF state of the outside air supply fan 111 having a fixed number of rotations. For example, the main controller 51 causes the outside air supply fan 111 to turn into an ON state when a CO₂ concentration detected by one of the remote sensors 70 takes a value more than a threshold value, and causes the outside air supply fan 111 to turn into an OFF state when the CO₂ concentration takes a value equal to or less than the threshold value.

(4-4) Modification D

The foregoing embodiment or each of the foregoing modifications concerns the case where the second unit 20 includes the air supply fan 21. Alternatively, in the air conditioning system 1, the second unit 20 does not necessarily include the air supply fan 21.

(4-5) Modification E

In the foregoing embodiment, the sum of the airflow volumes from the plurality of first units 10 is calculated from the sum of airflow volumes detected by the plurality of first airflow detectors 12; however, a method of calculating the sum of the airflow volumes from the plurality of first units 10 is not limited thereto. For example, the sum of the airflow volumes from the plurality of first units 10 may also be calculated using the third airflow detector 23.

(4-6) Modification F

The foregoing embodiment concerns the case where the airflow volume from the outside air supply fan 111 changes in accordance with a CO₂ concentration; however, a parameter that changes the airflow volume from the outside air supply fan 111 is not limited to the CO₂ concentration. The parameter that changes the airflow volume from the outside air supply fan 111 may include any parameter in addition to the CO₂ concentration. Alternatively, the parameter that changes the airflow volume from the outside air supply fan 111 may include a combination of the CO₂ concentration with another parameter.

(4-7) Modification G The foregoing embodiment concerns the case where the air conditioning system 1 adjusts a temperature and a CO₂ concentration of the target space 100; however, the air conditioning system 1 may perform another air conditioning in addition to the temperature and the CO₂ concentration. For example, the air conditioning system 1 may be configured to adjust a humidity of the target space 100.

(5) Features

In the air conditioning system 1 described above, the controller 50 sets the sum of the airflow volumes from the plurality of first units 10 to be equal to or more than the airflow volume from the outside air supply fan 111 as a second fan, the airflow volume from the indoor fan 120 as a second fan, or the airflow volumes from both the outside air supply fan 111 and the indoor fan 120. Therefore, a value obtained by subtracting a volume of outside air OA and/or indoor air RA as second air from a volume of supply air SA as first air does not take a negative value. As a result, the air conditioning system 1 controls a pressure inside the second unit 20 such that the pressure does not become a positive pressure (e.g., a pressure equal to or more than an atmospheric pressure), and inhibits backflow of the supply air SA (as the first air) and the second air. In the foregoing embodiment, the second air refers to the outside air OA. In Modification A, the second air refers to the outside air OA and the indoor air RA or only the indoor air RA. In Modification B, the second air refers to the outside air OA.

While various embodiments of the present disclosure have been described herein above, it is to be appreciated that various changes in form and detail may be made without departing from the spirit and scope of the present disclosure presently or hereafter claimed.

### REFERENCE SIGNS LIST

1: air conditioning system

10: first unit

11: first fan

12: first airflow detector

20: second unit

22: heat exchanger

28, 29: intake port

40: duct

50: controller

111: outside air supply fan (example of second fan)

112: outside airflow detector (example of second airflow detector)

120: indoor fan (example of second fan)

121: indoor airflow detector (example of second airflow detector)

### CITATION LIST

### Patent Literature

Patent Literature 1: JP H10-253132 A

1. An air conditioning system comprising:
a plurality of first units each including a first fan configured to blow first air into a target space;
a second unit including a heat exchanger and an intake port;
a duct through which the second unit distributes the first air to the plurality of first units;
a second fan provided upstream of the intake port and configured to introduce second air into the second unit through the intake port from the outside of the second unit; and
a controller configured to control the plurality of first fans of the plurality of first units,
wherein
the plurality of first units each include a first airflow detector configured to detect the airflow volume from a corresponding one of the first units,
the second unit makes exchange heat at least the second air introduced by the second fan with the heat exchanger to generate the first air and sends the first air to the duct, and
the controller controls the plurality of first fans in accordance with a result of comparison between a sum of airflow volumes detected by the plurality of first airflow detectors of the plurality of first units and the airflow volume from the second fan so as to avoid the first air or the second air from flowing out of the intake port to the outside of the second unit, by making a sum of airflow volumes from the plurality of first units to be equal to or more than an airflow volume from the second fan.

2. An air conditioning system comprising:
a plurality of first units each including a first fan configured to blow first air into a target space;
a second unit including a heat exchanger and an intake port;
a duct through which the second unit distributes the first air to the plurality of first units;
a second fan provided upstream of the intake port and configured to introduce second air into the second unit through the intake port from the outside of the second unit;
a second airflow detector configured to detect an airflow volume from the second fan; and
a controller configured to control the plurality of first fans of the plurality of first units, wherein
the second unit makes exchange heat at least the second air introduced by the second fan with the heat exchanger to generate the first air and sends the first air to the duct, and
the controller controls the plurality of first fans in accordance with a result of comparison between the airflow volume detected by the second airflow detector and the sum of the airflow volumes from the plurality of first units so as to avoid the first air or the second air from flowing out of the intake port to the outside of the second unit, by making a sum of airflow volumes from the plurality of first units to be equal to or more than an airflow volume from the second fan.
